(19) United States
(12) Patent Application Publication
(10) Pub. No.: US 2010/0108581 A1
(43) Pub. Date: May 6, 2010

(54) WATER TREATMENT CARTRIDGES

(75) Inventors: Simon Richard Johnston, Foxsdale (GB); David John Owen Parkes, Colby (GB)

Correspondence Address: O''Shea Getz P.C., 1500 MAIN ST. SUITE 912, SPRINGFIELD, MA, 01115, US

(73) Assignee: STRIX LIMITED, Ronaldsway, Isle of Man (GB)

(21) Appl. No.: 12/596,580

(22) PCT Filed: Apr. 18, 2008
(86) PCT No.: PCT/GB2008/001362

§ 371 Date: Oct. 19, 2009

(30) Foreign Application Priority Data
Apr. 19, 2007 (GB) 0707599.7

(51) Int. Cl. C02F 1/68; B01D 27/10; B01D 27/08

(52) U.S. Cl. 210/86; 210/206; 210/130; 210/137

(57) ABSTRACT

A water treatment cartridge comprises an additive channel arranged so that only some of the water passing through the cartridge passes through it. The additive channel comprises means for automatically releasing an additive into the water in the channel. The additive channel is arranged to control the additive dose. The cartridge may also contain a water treatment or filter medium.

This application is entitled to the benefit of, and incorporates by reference essential subject matter disclosed in PCT Application No. PCT/GB2008/001362 filed on Apr. 19, 2008, which claims priority to Great Britain Application No. 0707599.7 filed Apr. 19, 2007.

### BACKGROUND OF THE INVENTION

1. Technical Field

The present invention relates to water treatment cartridges, in particular to cartridges for use in jugs and kettles in the home to purify, filter and enhance water for drinking.

2. Background Information

It is well known to provide water treatment cartridges which remove unwanted impurities from drinking water, thereby reducing any potential health related effects resulting from the presence of contaminants in the water supply. Such cartridges typically include activated carbon and/or an ion exchange resin. Activated carbon removes most organic compounds which can cause taste and odor problems, along with chlorine originating from disinfection processes carried out by the water supplier. Ion exchange resins work by exchanging contaminant ions in the water for those present in the resin, thus allowing the reduction or removal of inorganic materials such as cadmium, lead, copper, zinc, calcium, magnesium, nitrate and alkalinity. The presence of calcium, magnesium and alkalinity in the water can lead to hardness. Hard water has a detrimental effect on washing and laundering as well as forming an unpleasant scum on the surface of heated water e.g. in a teacup.

Consumer concerns about the potential negative effects that mains supplied water may have on their health has led to an increased used of water treatment cartridges in the home.

It has been proposed in WO 99/26883 to go further and seek to enhance the health benefits of drinking water e.g. by introducing enhancing additives into home-filtered water. Such additives may provide a flavoring or some kind of dietary supplement. In this proposal a water filter jug is fitted with a pump-action dispenser which allows a user to add a predetermined quantity of a liquid dietary supplement including, e.g. minerals, vitamins, homeopathic and herbal remedies, to the filtered water in the bottom of the jug. In this system the user must remember to dispense the additive into the filtered water. However the Applicant has recognized that the amount of additive in a given volume of water might not be constant, depending e.g. on the frequency of dispensing, the rate of filtration, and the amount of water poured out of the jug between dispensing strokes. For instance, a user may dispense the additive when the filtered water reservoir is full and then pour out only some of the water. At a later point of time more additive may then be dispensed inadvertently into the remaining water before it is poured out, thereby increasing the additive dose.

It has also been proposed, e.g. in WO 2005/092798, to dispose a dosing capsule at the bottom of a filter such that the filtered water drains out of the cartridge via the capsule and is supplemented with minerals or other health promoting additives. However, such arrangements can have several drawbacks. It is not possible to accurately control the amount of additive which is released from the capsule per unit volume of treated water as the release rate depends on flow rate and thus on the pressure head of water entering the cartridge. The relatively large volume of water passing by the capsule may cause the additive to be depleted too rapidly, requiring frequent capsule replacement. There can also be a problem when the receptacle receiving water from the filter becomes full and the cartridge is partially submerged. The immersed capsule at the bottom of the cartridge may then continue to release additive into the water and over-dosing may occur.

### SUMMARY OF THE DISCLOSURE

When viewed from a first aspect the present invention provides a water treatment cartridge comprising an additive channel arranged so that only some of the water passing through the cartridge passes through it, wherein the additive channel comprises means for automatically releasing an additive into the water therein.

Thus it will be seen that the present invention provides for the automatic release of an additive into water passing through the cartridge, without the need for a user to dispense the additive. This is clearly advantageous over systems where a user chooses how much additive to dispense. It can be particularly important that a uniform dose is added when the additive is a dietary supplement or health-related substance, so as to avoid overdosing.

Moreover, it will be seen that in accordance with the present invention only a selected portion of the water passing through the cartridge, i.e. that entering the additive channel, is supplemented with the additive. This can allow more control over how the water interacts with the additive release means. It is preferred that the selected portion is a minority portion. The Applicant has appreciated that dividing out a selected portion of the water flowing through the cartridge to enter the additive channel is one way in which the amount of water into which a dose of additive is released can be limited. This can make it easier to control the dose for a given volume of water passing through the cartridge, especially where the additive dose is relatively small compared to the volume of water being treated. Where a soluble additive substance is used, it may be desirable to reduce the rate of dissolution so that the additive source lasts longer. This can be achieved by limiting the amount of water entering the additive channel. It may also be advantageous to limit the amount of water flowing via the additive release means, and its flow rate, where the release mechanism is relatively slow e.g. where it takes time for the additive to leach out.

The portion passing through the additive channel can of course be mixed with the rest of the water either within the cartridge (as is preferred) or after they have exited from the cartridge. Either way the dose of additive will be diluted in the overall volume.

Cartridges in accordance with the invention could be used just to add the desired additive to water passing through them. In preferred embodiments however the cartridge comprises a water treatment medium for treating water passing through the cartridge, e.g. by removing one or more contaminants. Such a water treatment medium preferably comprises one or more porous filters, a bed of filter granules, and/or any other suitable purification means. In preferred embodiments the treatment medium comprises both carbon and an ion exchange resin. The cartridge therefore preferably has a similar function to well-known drinking water filter cartridges, except for the addition of the additive.

Preferably the water treatment cartridge is a gravity feed cartridge. This means that the rate of flow through the cartridge is determined solely by the pressure head of water held in a reservoir above the cartridge, for example in a liquid treatment vessel, and by the flow resistance presented by the cartridge. It will therefore be understood that when a cartridge is designed for use in a particular vessel having a reservoir for untreated water of a known size, and the flow resistance of the cartridge is known, then the average rate of flow through the cartridge is also known. This allows a suitable additive release means, for example one having a particular rate of additive release, to be used so as to provide a predetermined dose per unit volume of water flowing through the cartridge.

A suitable gravity feed cartridge comprises a cartridge body having an inlet at its upper end for receiving water to be treated and an outlet at its lower end for draining treated water. A water treatment medium comprising a bed of liquid treatment granules may be contained within the cartridge body, the granules being supported spaced from the outlet so as to define a drainage space below the granules. The additive channel may be embedded within the water treatment medium. The channel may have inlet(s) which control the flow of water into the channel relative to the flow of water through the treatment granules. The flow of water into the additive channel may depend on the pressure head of water. The additive channel may be arranged to exhaust water into the drainage space below the granules.

The outlet from the cartridge body may also be restricted so as to control the flow of liquid through the cartridge. It can be desirable to vary the flow rate of water draining from the cartridge to increase the residence time in the treatment or filter medium.

The additive channel can comprise any suitable arrangement for separating a volume of the total throughput and isolating it while it takes on the additive. The cartridge may be arranged to select and separate a portion of the water at any stage while it passes through the cartridge.

In a first set of embodiments the flow of water through the cartridge is divided into a majority portion for a main flow path and a minority portion for a subsidiary flow path constituting the additive channel.

This is novel and inventive in its own right and thus when viewed from a second aspect the present invention provides a water treatment cartridge comprising means for dividing the flow of water through the cartridge into a majority portion for a main flow path and a minority portion for a subsidiary flow path, wherein the subsidiary flow path comprises means for automatically releasing an additive into the water.

The additive may be added to a minority portion of the cartridge throughput whilst the majority portion simply passes straight through. Preferably though the main flow path through the cartridge comprises a water treatment medium as described hereinabove.

It can be seen therefore that in such arrangements a water treatment cartridge has a dedicated flow path for the automatic release of an additive into water passing through the cartridge.

The cartridge may be arranged to divide the flow by any suitable means, for example it may comprise a divided inlet or separate inlets to the main flow path and a subsidiary flow path forming the additive channel. The flow of water into the subsidiary flow path may be controlled by the size of its inlet or by a valve. Of course, the inlet to the subsidiary flow path may comprise one or more inlet openings. Providing a separate inlet to the subsidiary flow path allows a minority portion of the water to be siphoned off from the main throughput. The amount of water passing through the subsidiary flow path is arranged to be a relatively small fraction of the total throughput in order to ensure that the majority portion is treated e.g. filtered. Preferably the minority portion comprises no more than 10% of the total flow through the cartridge, more preferably 5% or less. This ensures that the overall treatment performance of the cartridge, i.e. bulk purification as well as additive release, is not detrimentally affected.

In a subset of the aforementioned embodiments the subsidiary flow path is formed by a generally tubular insert fitted inside the cartridge. The insert may be provided with one or more inlets which determine the flow rate into the subsidiary flow path. The size of the inlets is chosen so as to limit the portion of the through flow passing into the subsidiary flow path. The subsidiary flow path and thus the amount of water in the minority portion may be configured depending on the type of automatic release means (for example the release rate or solubility of the additive) and depending on the desired dose of a particular additive. Different cartridges may therefore be designed for different additive tablets. However, it is preferred that the subsidiary flow path provides a fixed minority portion of water for a given volume passing through the cartridge. This allows the same cartridge structure to be used for different applications, but with the automatic release means e.g. tablet being designed to provide a suitable additive dose. The insert may therefore be configured to accept different additive release means.

In preferred embodiments the additive channel is arranged advantageously to keep the additive release means separate from the treatment medium and prevent any reaction between them which could detrimentally affect either. For example the exit from the additive channel is preferably downstream of the treatment medium, so that the additive released into the selected or minority flow portion is not removed by the water treatment medium. In embodiments where the additive channel comprises a subsidiary flow path, the cartridge is arranged to divide out a portion of the main throughput into a parallel, independent flow passing along the subsidiary flow path. In other words, the subsidiary flow path could bypass some or even all of the water treatment medium.

Preferably the input to the additive channel is arranged downstream of the main cartridge inlet(s). This can allow the conventional inlet(s) to the cartridge to remain unchanged. The input to the additive channel may be arranged above the treatment medium, but preferably the additive channel and its inlet are embedded in the treatment medium. This ensures that the inlet to the additive channel is easily wetted and can help to avoid formation of undesired airlocks. In embodiments where the additive channel comprises a subsidiary flow path as described above, a constant ratio between the majority and minority portions is preferably maintained. The additive channel may also be advantageously arranged to select a portion of the water flowing through the cartridge after it has been partly treated e.g. filtered by the water treatment medium. This means that all of the water exiting the cartridge may have undergone a degree of filtration as well as an additive having been imparted.

So the additive channel could bypass all or some of the treatment medium. However in another set of embodiments, it does not bypass the treatment means at all, allowing the water to be both fully treated, e.g. filtered, and enhanced with the additive.

The cartridge may comprise any suitable means for selecting a portion of the treated water to pass through the additive channel. For example a divided flow path could be provided as is described in respect of earlier embodiments: e.g. separated outlets or exit paths, but which could be arranged to converge before water finally exits the cartridge.

However the Applicant has appreciated that an alternative to this offers more control over when water enters the additive channel and how much does so. Thus in some preferred embodiments the additive channel is configured to have a minimum pressure below which water cannot get to the additive release means. It follows that there must be a minimum pressure head of water in the cartridge (and any reservoir) either before any water can enter the additive channel or before it can contact the additive source once it has entered the channel.

This is considered novel and inventive in its own right and thus when viewed from a further aspect the present invention provides a water treatment cartridge comprising means for automatically releasing an additive when exposed to water, and an additive channel arranged to select a portion of the water passing through the cartridge and expose the selected portion to the additive release means when a minimum water pressure is present.

Thus it will be understood that a portion of water passing through the cartridge will only be selected to receive an additive if there is a large enough pressure head, for example a large enough volume of water in a reservoir above the cartridge. This can advantageously prevent a small through-flow, such as an accidental dribble into the cartridge, being overdosed. The additive will only be released into a volume of water which the cartridge is designed to treat.

Secondly, it will be appreciated that as water passes through the cartridge the pressure head will fall. Therefore selection and flow of water to the additive source will only occur during the first period of the cartridge's operation cycle. Once the majority of the design volume has passed through the cartridge, the additive dose will already have been received. Once the pressure drops below the minimum (e.g. as the reservoir above the cartridge is emptied) flow past the additive release means will stop. This means that the release means can be kept dry between cartridge use cycles. This can help to prevent premature degradation of say an additive tablet.

These advantages are realized most when the cartridge is employed in an appliance having a fixed-volume reservoir that is periodically filled and emptied.

This minimum pressure requirement can also prevent re-entry of water that has passed through the cartridge into the additive channel as the level of treated water rises to submerge the bottom of the cartridge.

There are several ways of achieving the result of requiring a minimum pressure to cause additive to be released into the selected volume of water. For example a pressure-sensitive valve such as a flap valve could be employed at the entrance to the additive channel. Alternatively a pressure-sensitive valve arrangement could be employed in the additive channel to control access to the additive release means. In other words the pressure criterion could be applied either to the selection of the volume of water or to its exposure to the additive release means.

Preferably however the additive channel is arranged to include a riser portion before the additive release means which requires the selected portion to flow generally upwardly (against gravity) from an inlet before proceeding generally downwardly (with gravity) to an outlet. Preferably the additive release means is arranged to contact the downward flow. Clearly with a riser portion, the pressure head of water above the inlet must be at least as high as the vertical extent of the riser in order for the water to overcome it to reach the additive release means. So long as this head exists water will flow up the riser and into the tube or area where it can contact the additive release means. The flow rate will be dependent on the head of water above the pressure minimum and the minimum bore of the additive channel.

There are many possible configurations which incorporate a riser portion of the kind described. For example the riser portion could be a tube open at its upper end for water to overflow into a larger tube or chamber containing the additive release means; or the riser could form one leg of a curved or angled tube which undergoes a reversal of direction such as an inverted U-shape or J-shape.

The outlet of the additive channel is preferably arranged to be isolated from the inlet. In some preferred embodiments the outlet is arranged so that, should the bottom of the cartridge become submerged, water can enter both the riser portion and the outlet portion. This can help to create an airlock in the additive channel in the vicinity of the additive release means which is therefore kept dry, however high the water level should rise. This prevents prolonged contact between the additive release means, for example an additive tablet, and the water which can lead to over-dosing and premature tablet degradation.

In preferred embodiments the cartridge is a gravity feed cartridge with an additive channel arranged so that only some of the water passing through the cartridge passes through it, wherein the additive channel comprises means for automatically releasing an additive into the water therein, such as an additive release tablet exposed to water in the additive channel. The main flow path and the additive channel may be arranged to exit the cartridge through a common particle filter. In some preferred embodiments, both the main and additive paths supply a drainage space defined in the cartridge below the water filter medium. A mesh or grille is preferably provided at the bottom of the drainage space, e.g. at the bottom of the cartridge body adjacent to the outlet, to retain any filter medium and/or additive tablet particles which may have been carried in the flow. A grille is often provided in the bottom of standard water treatment cartridges. This may obviate the need for a separate filter or mesh in the additive channel. Such an arrangement can advantageously prevent any filter medium and/or undissolved additive tablet particles from blocking the cartridge outlet or being carried out of the cartridge.

Additionally or separately, the additive channel may comprise a filter for undissolved additive tablet particles. Such a filter may comprise a porous membrane or simply a coarse mesh or grille to prevent any particles from the additive formulation being carried in the additive flow. In some embodiments a porous cover or sheath is arranged over the exposed surface of the additive release means. This can serve to envelop and hold together the additive tablet as well as holding back any debris. In some embodiments this sheath could be a porous nylon mesh. In other embodiments a mesh is arranged in the additive channel to support the tablet as well as to retain any breakaway particles.

Preferably the additive release means provides one or more enhancing additives selected from the group consisting of: vitamins; minerals; antioxidants; herbal remedies; homeopathic remedies; probiotics; antibiotics; and flavorings.

The enhancing additive may be added to the selected portion of water by any suitable means e.g. through a selective membrane, osmosis, chemical reaction or physical interaction. Whatever the mechanism for release, the additive release means preferably provides an additive dose which is broadly proportional to the volume of water in the additive channel. In preferred embodiments this may be achieved in an uncomplicated manner by using an additive source which is soluble in water. Such an additive source may be formed as a soluble tablet or contained within a capsule which is itself soluble or otherwise breached in use. Preferably the additive source comprises a tablet having an insoluble substrate matrix, for example a reticulated, e.g. cellulosic substrate, holding a soluble additive substance. In such an arrangement the water would therefore cause the additive to leach out of the substrate of the additive release tablet.

It is desirable that the tablet or capsule cannot move as agitation in the water flow may affect the rate of dissolution or leaching. The cartridge may therefore comprise a holder or retaining means for the tablet to ensure that the amount of water flowing past the source is fixed.

Where, in accordance with preferred embodiments, the additive release means comprises a solid tablet, it may be arranged in the additive channel so that the water in the channel contacts only one face thereof. However in some preferred embodiments the tablet is held so that water can flow over both faces thereof. This can advantageously increase the wetting area and thus the dose rate. In either case the additive channel is preferably configured, e.g. with a suitable baffle or protrusion, to ensure that all the water therein comes into contact with one of the faces.

The Applicant has discovered, however, that additive release tablets placed in the water flow path do not provide a uniform additive release rate throughout their lifetime, even when the rate of flow past the tablet is constant. This is because it has been found that the additive release rate can depend both on the surface area of the additive tablet and the remaining volume of soluble additive material. The latter is a factor where migration of the additive through an insoluble substrate matrix takes place. When combined these two phenomena can give a highly non-linear additive release. However in preferred embodiments of the invention the means for automatically releasing an additive is configured so that the surface area of the additive mass exposed to water in use is controlled so as to control the rate of additive release.

It will be appreciated that the problem of controlling the release rate of an additive exists whenever release means in tablet form is used to release an additive into water, whether in a water treatment cartridge or any other system for enhancing water with an additive. This feature is therefore considered novel and inventive in its own right and thus when viewed from a yet further aspect the present invention provides an additive release arrangement for releasing an additive into water comprising an additive mass wherein the surface area of the additive mass exposed to water in use is controlled so as to control the rate of additive release.

In accordance with this aspect of the invention it has been found that by controlling the exposed surface area the rate at which additive is released can be made more constant.

In preferred embodiments of all of the foregoing aspects of the invention, the exposed surface area of the additive mass from which dissolution/additive release can take place is limited to a proportion of the total surface area. This could be achieved by the additive mass itself—e.g. a suitable cap, coating or sealing layer partly covering the surface. Equally it could be a function of how the additive mass is mounted—e.g. in a water treatment cartridge. By limiting the available surface area for additive release, e.g. the area exposed to water, to a proportion of the surface area of additive, the rate of release of additive into the water has a weaker dependence on the reducing surface area of the whole mass, giving better control of the release rate.

The exposed surface area could be a fixed absolute value (although it will naturally increase as a proportion of the total surface area as additive is leached away). However, it has been found that if the absolute exposed surface area is arranged to increase as additive progressively leaches out of the additive mass, to compensate for the dependence of release rate on the volume of additive remaining, then the overall rate of additive release can be kept more uniform. Preferably, therefore, the exposed surface area of the additive substance contained in the additive mass is arranged to increase as the additive mass dissolves. Increasing the exposed surface area could be achieved through the housing of an additive tablet but preferably the shape of the tablet (and hence the shape of the underlying substrate matrix) is adapted to give rise to an increasing exposed surface area as the additive mass leaches out. In preferred embodiments, therefore, the shape of the solid form is such that the rate of additive release is maintained substantially uniform while additive is progressively leached out of the additive mass. It will be understood that many different overall shapes of the solid form may be used, but preferably the shape is one which includes a taper towards the exposed face. Thus as additive is removed from the substrate matrix, the area available for additive release will increase. Clearly the precise shape can be determined empirically to give the most desirable release profile. In some preferred embodiments for example the tablet is frusto-conical with the exposed surface provided by the truncated top. The sides may be coated or covered. As additive is progressively released out of the substrate matrix, the available surface area for the remaining volume of additive substance increases towards the bottom of the cone. This can be designed to compensate for the reduced amount of additive remaining as the additive is used up.

By providing in accordance with preferred embodiments an additive tablet in its own flow path having a controlled flow, the additive channel may, as previously described, also be arranged so as to keep the tablet dry once a charge of water has received an additive dose, thus preventing excessive dosing. This is particularly advantageous in arrangements where the cartridge may be at least partially immersed in treated water. For use in water treatment vessels such as jugs, it is known that a cartridge having a shape which is tapered in a curved manner from the top to the bottom of the cartridge reduces the likelihood of the cartridge being wetted when water is poured from the vessel and is therefore preferred. For use in kettles, the additive channel may be arranged to prevent the ingress of steam which could cause excess dissolution/additive release.

Except where they are mutually exclusive from a technical point of view, all of the features described above with respect to any embodiments may of course be provided in any other embodiments, e.g. the general features of a gravity feed cartridge.

It will also be appreciated that the present invention covers a conventional water treatment cartridge which has been modified to select a portion of the water passing through it to receive an additive. For example, an insert which provides an additive channel and means for retaining an additive release tablet can be fitted into a conventional water treatment cartridge without changing the overall shape and operation of the cartridge. Thus cartridges in accordance with the invention may be advantageously retrofitted in existing water treatment appliances e.g. water filter jugs or kettles.

The present invention extends to a water treatment appliance or vessel comprising a water treatment cartridge as described hereinabove. The appliance may be a vessel for treating and storing water, e.g. a jug. The appliance may alternatively be a vessel for treating, cooling and storing water, e.g. a chiller jug. The appliance may also be a vessel for treating and heating water, in particular for boiling water, e.g. a kettle jug.

### BRIEF DESCRIPTION OF THE DRAWINGS

Some preferred embodiments of the present invention will now be described, by way of example only, and with reference to the accompanying drawings, in which:

FIG. 1 is a perspective view of a water treatment cartridge in accordance with embodiments of the present invention;

FIG. 2 is a front view of a vertical cross-section through the cartridge of FIG. 1 according to a first embodiment of the present invention;

FIG. 3 is a perspective side view of a vertical cross-section through the cartridge of FIG. 1 according to the first embodiment of the present invention;

FIG. 4 is a front view of a vertical cross-section through the cartridge of FIG. 1 according to a second embodiment of the present invention;

FIG. 5 is a perspective side view of a vertical cross-section through the cartridge of FIG. 1 according to the second embodiment of the present invention;

FIG. 6 is another perspective side view showing the cartridge according to the second embodiment of the present invention partially cut away;

FIG. 7a is a perspective view of the tablet holder of the second embodiment in its assembled condition and FIG. 7b shows the tablet holder molding in its pre-assembly state;

FIG. 8a is a perspective view of an assembled tablet holder according to an alternative version of the second embodiment and FIG. 8b shows the tablet holder molding in its pre-assembly state;

FIGS. 9a-9c schematically show the passage of water at different times through a cartridge according to one of the second embodiments;

FIGS. 10a-10^{c} schematically show the passage of water at different times through the cartridge of FIG. 9, but in a situation where the cartridge cannot drain freely;

FIG. 11 is a graph depicting the amount of additive released from a soluble tablet as a function of water throughput for three different tablet forms;

FIG. 12 shows an embodiment of an additive release arrangement, in perspective view (FIG. 12a) and in cross-section (FIG. 12b);

FIG. 13 is a schematic representation of the leaching of vitamin particles from a tablet matrix according to embodiments of the present invention; and

FIG. 14 schematically shows a variation to the second embodiment.

### DETAILED DESCRIPTION OF THE INVENTION

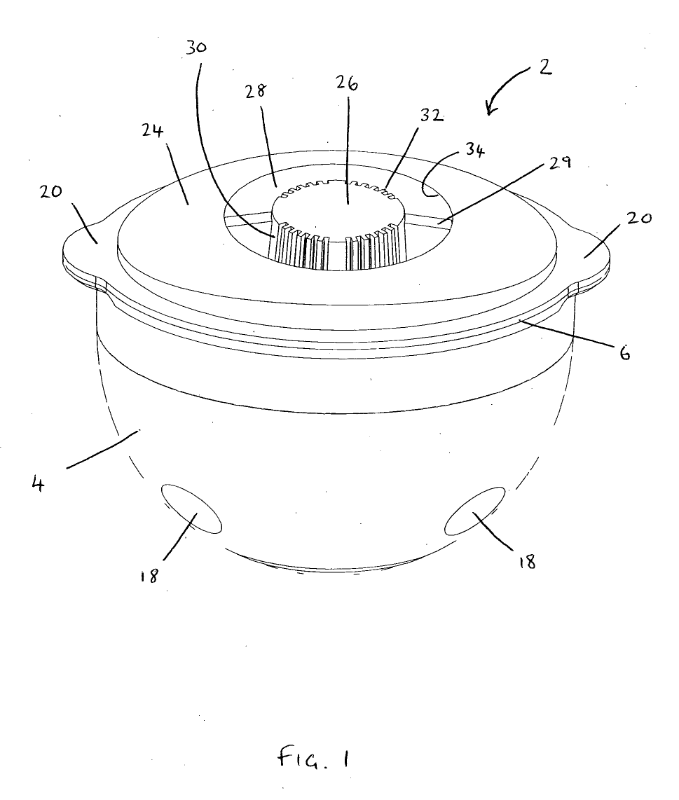

With reference to FIGS. 1 to 6 there is shown a water treatment cartridge 2 containing water treatment granules (not shown). The granules may comprise ion exchange particles, activated carbon particles, mineral substances or other treatment materials, or mixtures thereof.

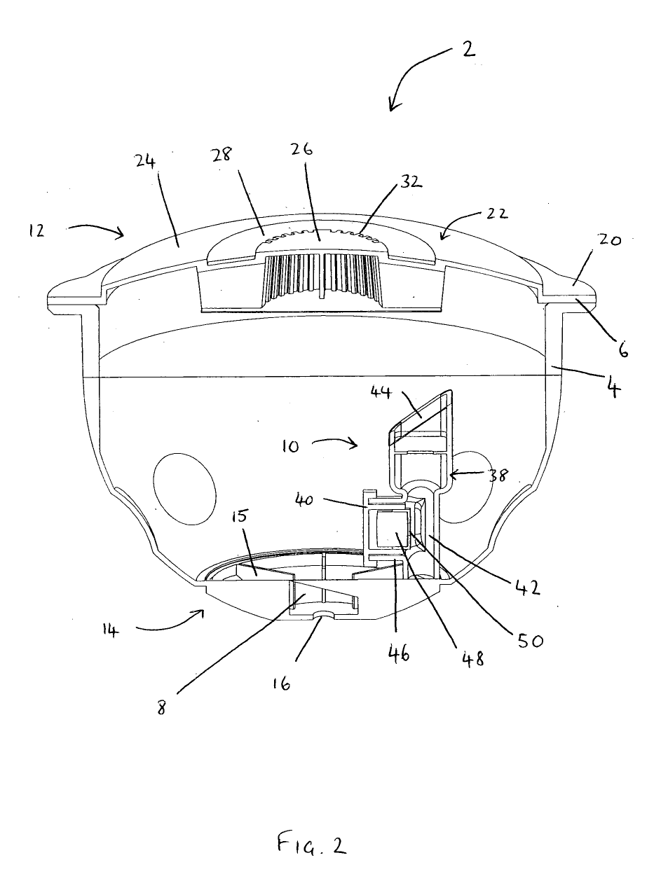

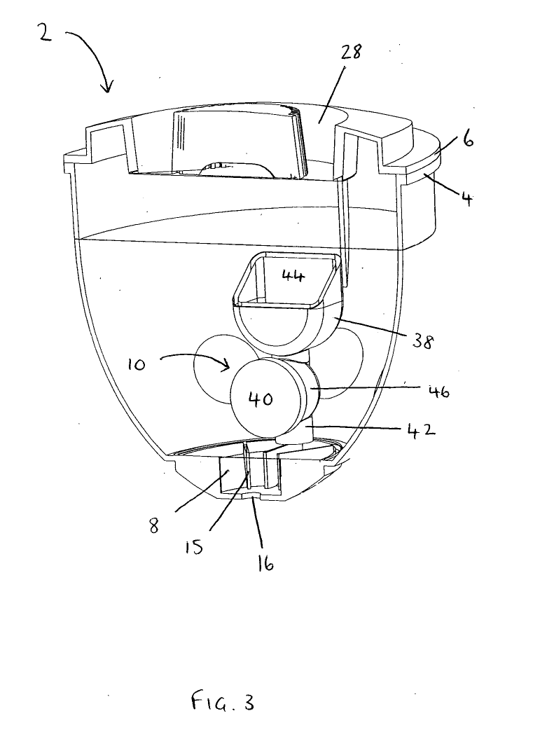

As can be seen from FIGS. 2 and 3, the cartridge 2 comprises four main components—a body 4, a cap 6, a drainage space 8, and an additive release channel 10. The water treatment granules are retained in the cartridge body 4 above the drainage space 8. The cartridge body 4 is generally elliptical in cross-section, tapering in an arcuate manner from its upper end 12 to its lower end 14. The cartridge 2 is of molded plastics.

The drainage space 8 comprises a plurality of ribs 15 extending radially from the inner wall of the cartridge body 4. A grille (not shown) may also be provided in the drainage space 8. An outlet 16 is provided in the lower end 14 of the cartridge body 4, at the bottom of the drainage space 8. The outlet 16 may be sized so as to restrict the flow of water through the cartridge e.g. to give a desired residence time for the liquid passing through the cartridge. Typically the outlet 16 is about 4 mm in diameter.

The cartridge body 4 is provided with four indentations 18 around its circumference which act as finger grips for a user. The upper end 12 of the cartridge body 4 is provided with two mounting lugs 20 which serve to mount the cartridge 2 in an appliance in a bayonet-style fitting. As can be seen from FIG. 1, these lugs 20 are generally arcuate in shape and have a chamfered outer edge. The mounting lugs 20 are aligned with the major axis of the cartridge body 4. The chamfered edge of the lugs 20 acts to cam the cartridge into position when mounted in an appropriate appliance.

The cap 6 is welded, for example ultrasonically welded, to the upper part 12 of the cartridge body 4. The upper surface 22 of the cap 6 has an outer region 24 free from any inlet openings. A circular central region 26 of the upper surface 22 is spaced from the outer region 24 by an annular channel 28. The annular channel 28 is split into two halves by a pair of diametrically aligned walls 29 extending across the channel 28.

The radially inner wall 30 of the annular channel 28 is provided with a plurality of longitudinally extending ribs 32. Inlet openings are provided between the ribs. The radially outer wall 34 of the channel 28 may also be provided with ribs and inlet openings (not shown).

The additive channel 10 is molded or fitted inside the cartridge body 4 before the cartridge is filled with water treatment granules. The additive channel 10 comprises a subsidiary flow path formed by a generally tubular molding 38 and a tablet holder 40. The molding 38 comprises a vertical flow tube 42 having an upper inlet opening 44. The vertical height of the additive release part 10 is less than the vertical space in the cartridge body 4 between the drainage space 8 and the cap 6. The additive channel 10 is therefore embedded within the treatment granules after the cartridge has been filled. This ensures that the inlet opening 44 is easily wetted by water flowing through the granules and avoids formation of an airlock, so that the amount of water entering the subsidiary flow path is approximately constant relative to the flow through the cartridge.

The inlet opening 44 is relatively wide compared to the diameter of the flow tube 42. The inlet opening 44 therefore acts as a small reservoir providing water to the subsidiary flow path, while the size of the flow tube 42 determines the flow rate through the subsidiary flow path.

The tablet holder 40 is connected to a side opening 46 in the flow tube 42. The tablet holder 40 retains a tablet 48 comprising a formulation which releases a soluble additive substance e.g. comprising vitamin C in soluble form when it comes into contact with water. Only part of the tablet surface is exposed through the side opening 46 to water flowing down the tube 42. The rest of the tablet surface is covered by the holder 40.

A porous sheath 50 comprising a nylon mesh covers the exposed surface of the tablet 48. The sheath 50 allows the additive to be released into water as it flows past the side opening 46 but prevents any tablet matrix particles from entering the flow.

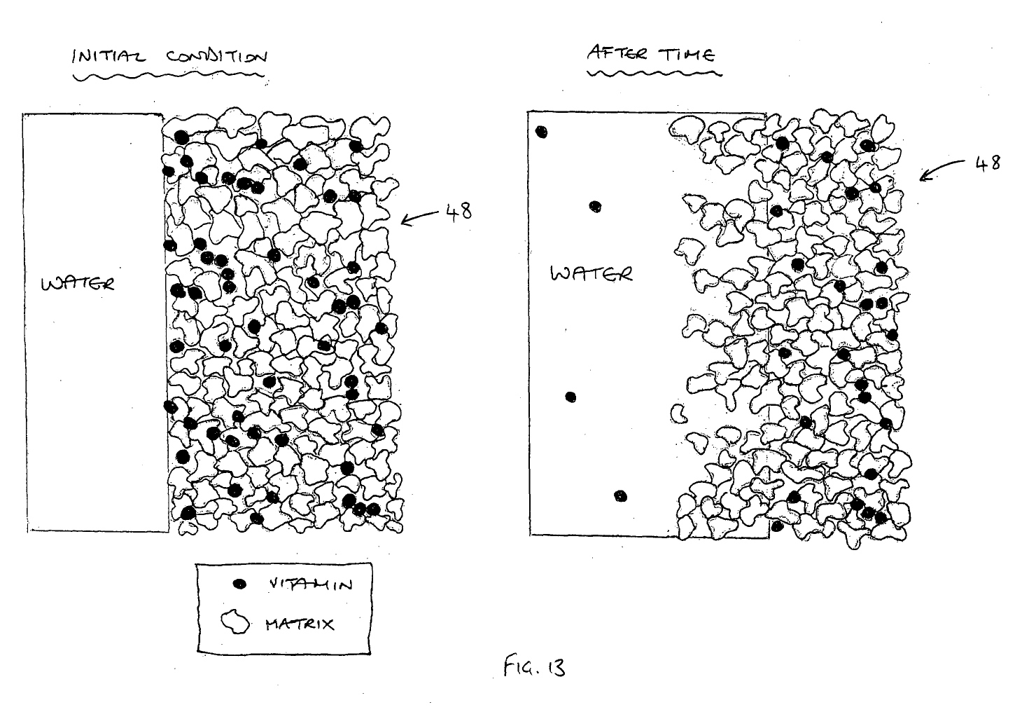

The tablet 48 comprises an insoluble matrix supporting the soluble additive. The excipient matrix may be comprised of one or more of the following: methacrylic acid copolymers e.g. Eudragit™ available from Degussa; cellulose derivatives e.g. ethyl cellulose; methyl cellulose; hydroxypropyl cellulose; hydroxypropyl methyl cellulose; ethyl methyl cellulose; and carboxymethyl cellulose. The leaching of an additive e.g. vitamin from a matrix in a tablet is shown schematically in FIG. 13. In its initial condition, the tablet 48 comprises an insoluble matrix which has soluble vitamin particles dispersed throughout its volume. As the additive particles are leached out of the tablet over time, it has been found that additive release rate can depend on both the surface area of the tablet which is exposed to water and the mass of additive particles remaining in the tablet.

The tablet 48 may be of any suitable shape and form. In order to control the available surface area for additive release, as is preferred, the holder can be designed to cover certain parts of the tablet or otherwise limit the surface area which is able to interact with water flowing down the tube 42. The use of a separate holder 40 allows a standard molding 38 to be integrally formed in the cartridge 2. To this molding 38 a holder 40 can be fitted which is adapted to the type of tablet or other additive release means. For example, a generally conical holder may be used with a tablet having a truncated conical shape. The exposed surface area of the additive mass can be arranged to thereby increase as the additive is progressively leached out of the tablet. This can be designed to compensate for a decreased rate of release over time as the additive is exhausted, such that the amount of additive released is maintained approximately constant over the lifetime of the tablet. This may be particularly important where the additive has health-related effects.

Alternatively the separate holder 40 may be omitted and the tubular molding 38 may itself retain an additive release tablet or other additive release means. Such tablets may themselves be treated e.g. with a coating to limit the surface area of the additive mass.

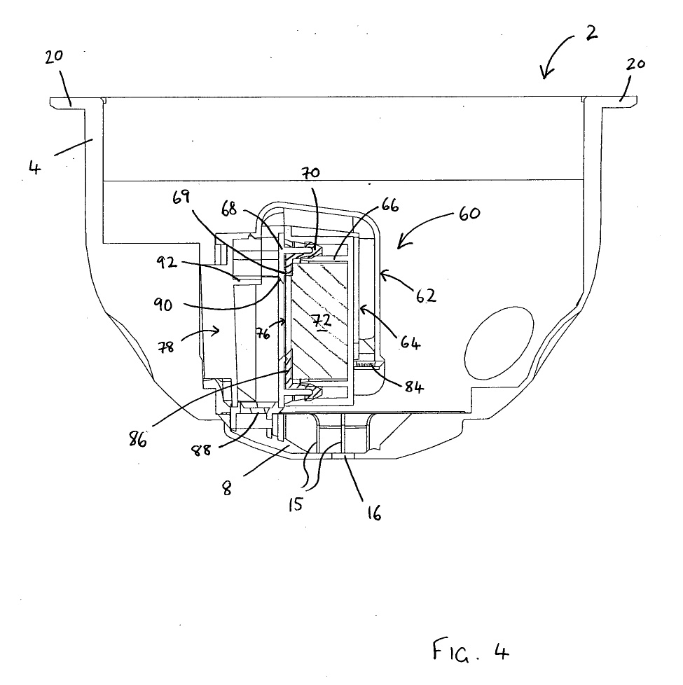

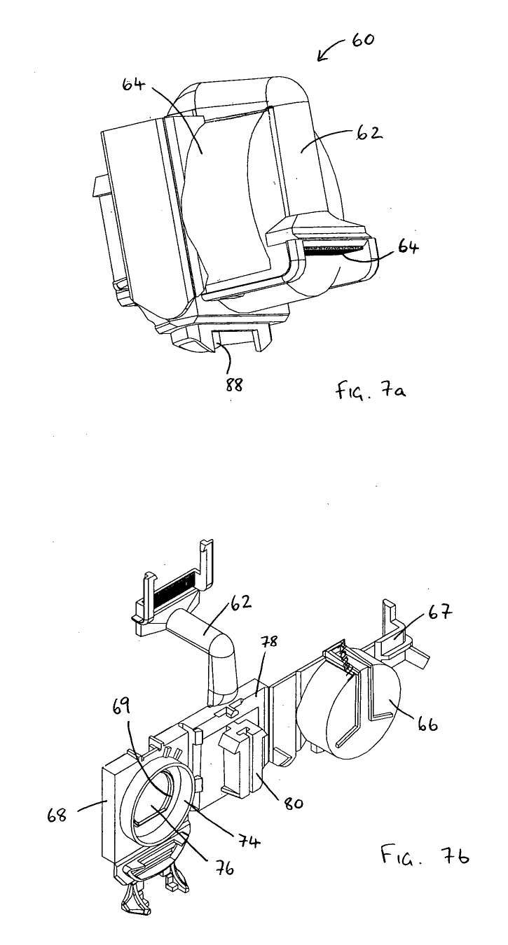

There is shown in FIGS. 4 to 6 another embodiment of an additive channel in a cartridge. The features of the cartridge 2 are the same as described above, except that in these Figures it will be seen that the cap has been omitted. In this embodiment the additive channel comprises a U-tube device 60 which is assembled and fitted inside the cartridge body 4 before the cartridge 2 is filled with granules or other treatment medium. The device assembly 60 is shown in FIG. 7a and the molding from which it is formed is shown in FIG. 7b. The device 60 can be moulded in one piece with integral hinges formed between the folding portions.

The U-tube device 60 generally comprises a riser tube 62 in the form of an upturned L-shape and a tablet holder 64. The tablet holder 64 is formed in two halves from a tablet retaining portion 66 and an apertured cover 68. The tablet retaining portion 66 is shown here as a discoid receptacle for a circular tablet, but of course any tablet shape may be used and the device 60 may be shaped accordingly to match the tablet. An annular sealing member 70 provides a watertight seal between the two halves.

In order to assemble the U-tube device 60 from its molding, a tablet 72 is placed in the retaining portion 66. A sealing member 70 is fitted over the outer rim 74 surrounding the aperture 76 in the tablet cover 68. The cover portion 68 is folded over onto the back portion 78 of the device, the interior of which forms the outlet path of the U-tube device 60. These three steps can be carried out in any order. The tablet retaining portion 66 is then folded across onto the cover portion 68, engaging against the seal 70 to form a closed tablet holder 64. The cover portion 68 has a circumferential flange 69 forming an inner rim to the aperture 76. The flange 69 acts to compress the sealing member 70, helping to form a tight seal between the cover portion 68 and the retaining portion 66, with the tablet 72 sealed inside. A side clasp 67 attached to the retainer 66 engages over both the cover portion 68 and the back portion 78 to hold the three layers firmly together. Finally, the riser tube 62 is folded down over the tablet holder 64 and clipped into place.

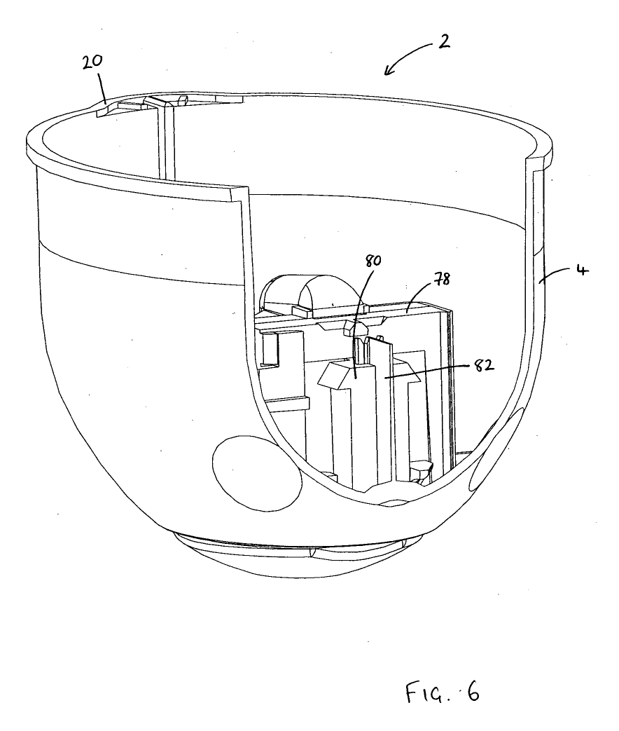

The back portion 78 of the device 60 comprises a T-shaped connector channel 80 which allows the device 60 to be slid onto a corresponding vertical rib 82 molded inside the cartridge 2, as is most clearly seen from FIG. 6. Any other connection means may of course be used instead.

The formulation of the tablet 72 is the same as previously described above, e.g. comprising an insoluble matrix containing a soluble additive component.

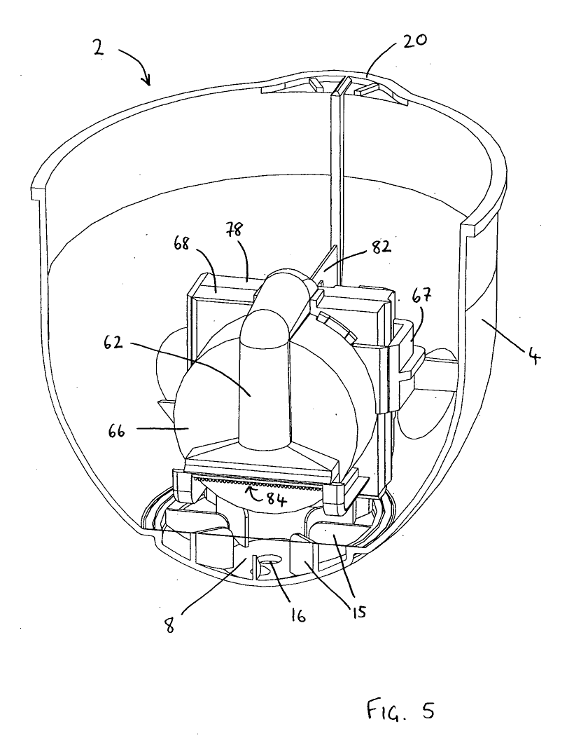

Turning to FIGS. 4 and 5, it will be seen that there is formed in the assembled device 60 a flow path in the shape of an upturned U-bend. At the bottom of the riser tube 62 there is an inlet 84 which is covered with ribs or a mesh/grille, thereby allowing the influx of water but barring the entry of water treatment granules. The inlet 84 to the riser tube 62 is close to the bottom of the treatment material inside the cartridge, the significance of which will become apparent from the description below. The L-shaped riser tube 62 extends vertically up the side of the tablet retaining portion 66 and across the top of the device 60, where it communicates with the interior of the back portion 78. An outlet 88 at the bottom of the back portion 78 communicates with the drainage space 8 and main cartridge outlet 16.

As is most clearly seen from FIG. 4, the tablet 72 is sealed inside the volume defined by the tablet retaining portion 66 and the cover portion 68. The sealing member 70 is compressed between the walls of the tablet retaining portion 66 and the rims 69, 74 of the cover portion 68. Furthermore, it will be seen that the sealing member 70 includes an inwardly and radially extending, circumferential flange 86 which covers the periphery of the tablet 72 on one side and the inside area of the cover portion 68 around the aperture 76 on the other side. The cover portion 68 and its inner rim 69 compress the sealing flange 86 against the tablet 72 to give a watertight seal.

A surface of the tablet 72 is exposed through the aperture 76 in the cover portion 68. The tablet surface is exposed to the volume inside the back portion 78. This space may simply allow water passing up and along the riser tube 62 to flow down and over the exposed surface of the tablet 72 before exiting from the outlet 88 at the bottom of the back portion 78. However, the device 60 comprises some features which are specifically designed to control the way in which water flowing through the device comes into contact with the tablet 72.

Firstly, the aperture 76 in the cover portion 68 has a chamfered edge 90 which is sloped inwardly from a larger diameter aperture on the water side to a smaller diameter aperture on the tablet side. This helps to encourage water which is dripping or trickling down the surface of the cover portion 68 to run onto the exposed surface of the tablet 72, where it can be absorbed into the tablet matrix. The presence of the sealing flange 86 around the inside periphery of the aperture 76 ensures that water cannot leak around the tablet 72 and that only the selected surface area is wetted. The chamfer 90 also helps water droplets to slide out of the bottom of the aperture 76 and down to the outlet 88. The sealing flange 86 also has a corresponding chamfer around its lower half so as to provide a continuously sloping surface down which droplets can slide away from the tablet face. This is important because additive particles which are leached out of the tablet 72 to its surface need to be dissolved and transported away.

A second feature which affects the movement of water in the device 60 is the presence of a diverter 92 protruding from the inside wall of the back portion 78, generally opposite the top edge of the aperture 76. Although a diverter ledge 92 is shown, any suitable protrusion such as a rib or pip may be used. The effect of the protruding ledge 92 is to direct the flow of water onto the exposed surface of the tablet 72. The diverter 92 also narrows the exit channel at this point and thus speeds up the flow. The diverter 92 can be important when the flow is not continuous but is more of a trickle or a series of drips. In this case the ledge 92 helps to form droplets which will then drip or dribble onto the exposed tablet surface opposite.

The U-tube device 60 is therefore arranged so as to ensure that as much as possible of the selected portion of water passing through the device 60 comes into contact with the tablet, wetting it and flushing out the additive component(s).

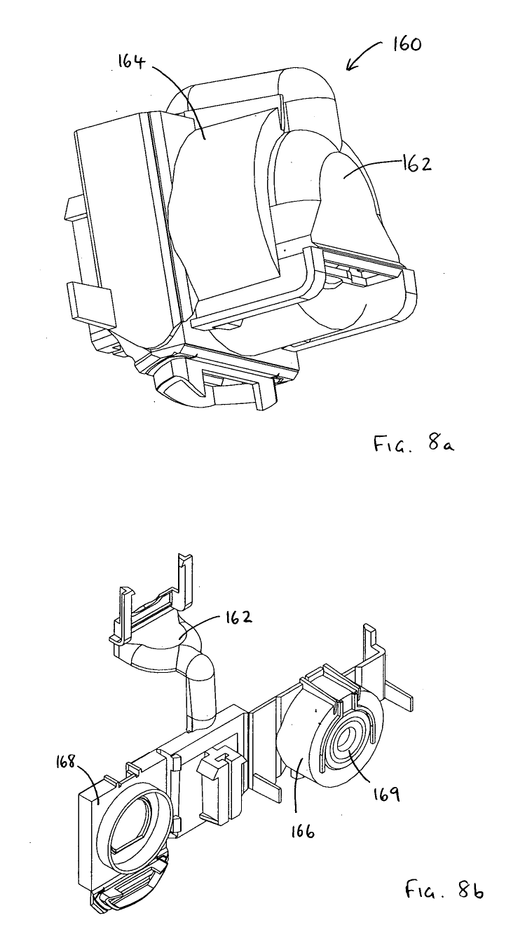

An alternative embodiment of a U-tube device 160 is shown in FIG. 8. As in the previous embodiment, the device 160 generally comprises an L-shaped riser pipe 162 and a tablet holder 164. In this embodiment the inlet pipe 162 is wider than in the previous embodiment, which can help to ensure that the inflow of water to the U-tube is not restricted. However the tube is not widened across the top of the device, as it is preferred that once the water level is high enough to pass the U-bend it trickles down the tablet side. There is no entrance mesh in this embodiment.

The other main difference in the embodiment of FIG. 8 is that the tablet retaining portion 166 is not a rigid molding and instead comprises a compliant cap 169 which protrudes into the retainer and contacts a tablet in use. A tablet is pressed into the retaining portion 166 while assembling the device 160. When the retaining portion 166 is folded against the cover portion 168, the tablet is pushed back against the compliant cap. This helps to seal the tablet into the holder 164 and prevent it from moving. Such a compliant holder is generally useful and applicable to other embodiments. The other features of the device 160 correspond to those previously described with respect to FIGS. 4-7 and thus will not be described again.

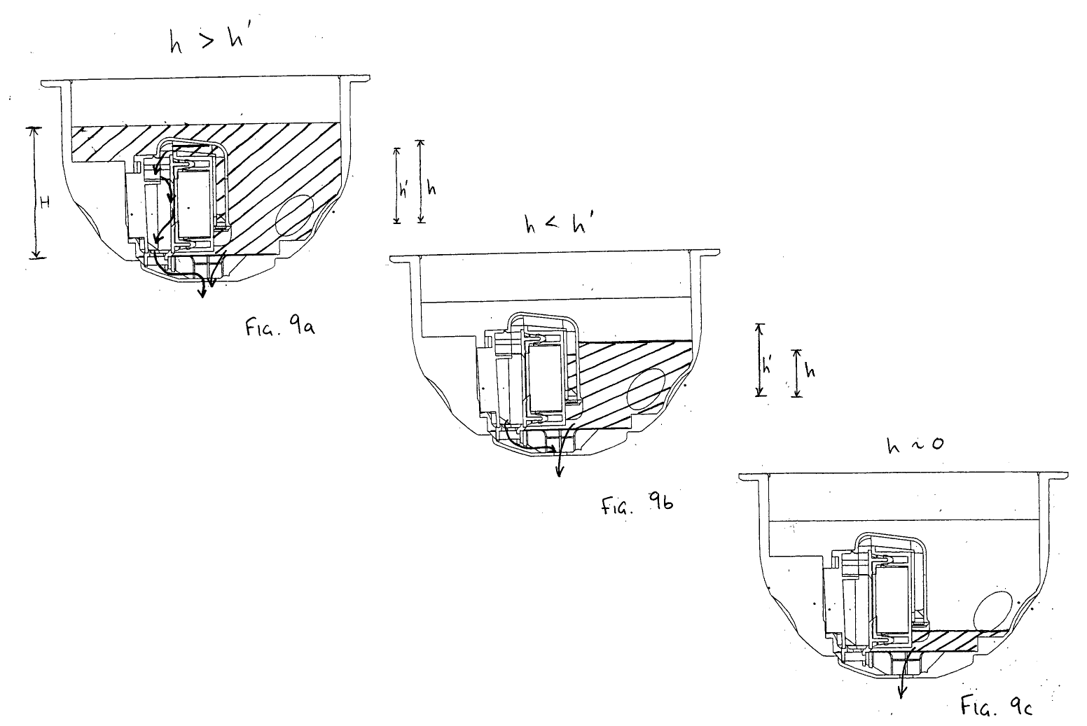

Operation of the U-tube device, which is general to all of its embodiments, will now be described with reference to FIG. 9. When the cartridge is first filled with water, a pressure head H of water is generated. Due to the flow resistance of the treatment material and the size of U-tube inlet there is a pressure loss which means that a smaller pressure head h, proportional to the overall pressure head H, is generated in the U-tube device. As long as this pressure head h is greater than the height h′ between the U-tube inlet and its highest point, then water is forced up the riser and through the U-tube to the side where the tablet is exposed. As is shown schematically in FIG. 9a, the water which reaches the top of the U-tube can trickle down the other side, past the exposed tablet surface.

Once the water reservoir feeding the cartridge runs dry and the pressure head H drops below a certain level, the pressure head h in the U-tube is no longer sufficient to drive water across to the tablet side, as is shown in FIG. 9b. From this point on, any water left at the tablet side drains down to the main cartridge outlet. The tablet will be wetted with the water that it has already absorbed, but otherwise the device drains dry, as is shown in FIG. 9c. Thus, for a given reservoir size, for example in an appliance in which the cartridge is fitted, the total pressure head h can be calculated and the portion of the reservoir volume which will be selected to pass up and across the U-tube can be determined. This of course depends on factors such as the residence time of the filter cartridge (determined by the treatment material) and the dimensions of the U-tube. However it enables a predetermined volume of water to be selected and supplemented with an additive, thereby ensuring a uniform dose per unit volume of water passing through the cartridge. Moreover the U-tube arrangement ensures that water trickles past the exposed tablet freely and its flow is not hampered even if water below the cartridge starts to back up to the cartridge outlet. This is described in more detail below.

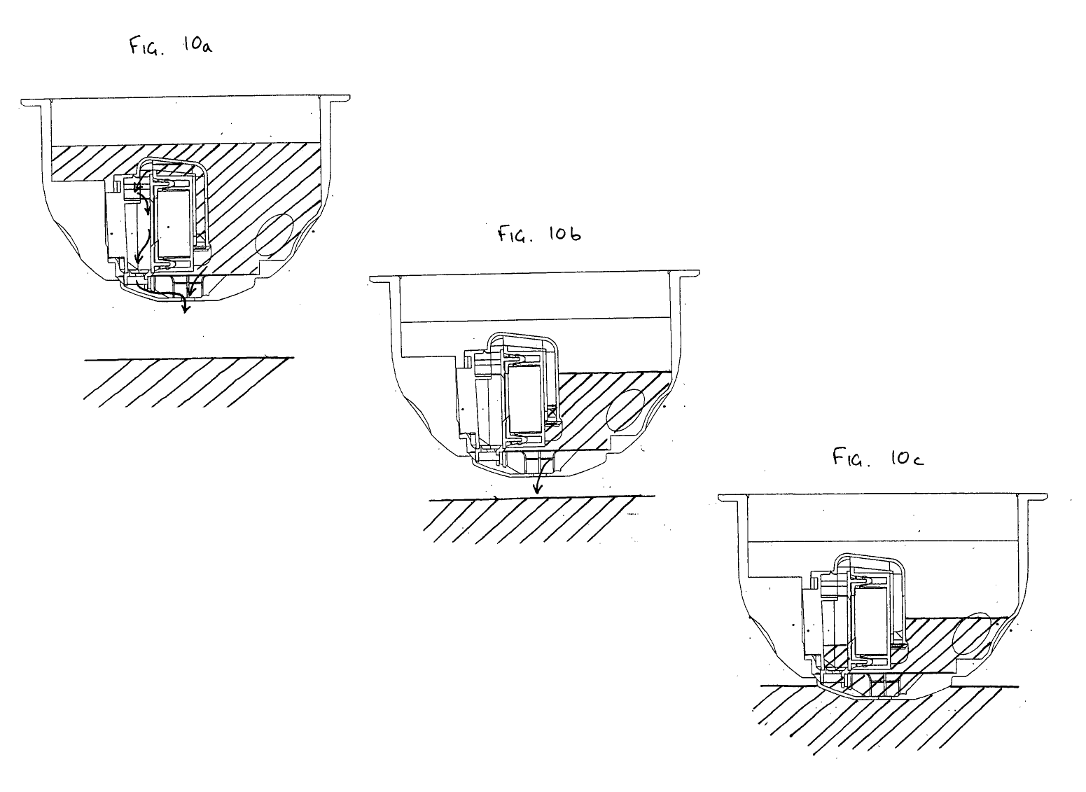

While FIG. 9 represents operation when there is a free gravity flow through the cartridge, it will be appreciated that in some situations the cartridge may not be able to drain freely and its lower end may instead be immersed. This could lead to the problem of water being backed up inside the cartridge to the level of the tablet, potentially leaching out a greater dose of additive than intended. Where the water reservoir above the cartridge and receptacle below are both full at the same times, dosing ‘spikes’ can be produced where water is not flowing freely past the tablet and is in prolonged contact instead. The U-tube arrangement provides some particular advantages in such a situation, as will now be described with respect to FIG. 10.

FIGS. 10a-10c depict the same points in time as FIGS. 9a-9c, with the difference that the rising water level e.g. in a receptacle below the cartridge affects its operation. The situation in FIG. 10a is the same as FIG. 9a as the water level has not reached the cartridge. In FIG. 10b the situation is the same as FIG. 9b except the water level has nearly reached the cartridge outlet before all of the water has drained out of the cartridge.

FIG. 10c shows what happens when the cartridge outlet is flooded while there remains a pressure head of liquid in the cartridge. Water can back up from the outlet into both the inlet and outlet of the U-tube. However the pressure head is insufficient to force water around the U-tube. Instead, in the absence of an outflow from the cartridge, the pressures equalize in the two sides of the U-tube, forming water plugs at the inlet and outlet which have a common level. An airlock is thereby formed. As long as the level of the outlet plug does not rise as high as the aperture through which the tablet is exposed, the tablet is not wetted further and stays dry in the trapped volume of air between the two plugs. It will be appreciated that if the tablet were retained in a straight tube arrangement rather than a U-tube arrangement, there is a greater risk of water backing up in the tube to the level of the tablet.

In any of the above embodiments the tablet may have a shape or exposed profile which changes the concentration of additive released (i.e. leached out) over time. This is advantageous over standard round or pill-shaped tablets which rapidly release their additive when first exposed to water and then suffer from a declining release rate as the additive leaches out.

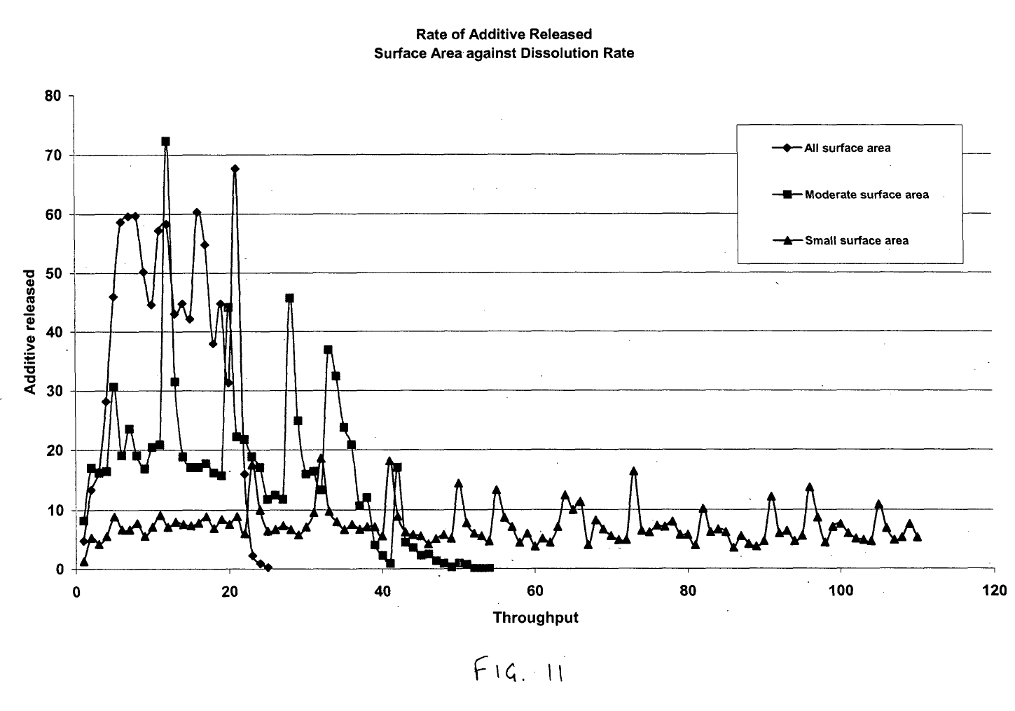

FIG. 11 is a graph showing the amount of additive released from a tablet measured as a function of cartridge throughput. Results are given for three different tablets. With the first tablet the whole surface area was exposed to flow. It can be seen that there was a rapid initial increase in the amount of additive released. The additive present in the tablet was then released at a high rate and became exhausted after a relatively low throughput.

With the second tablet a moderate surface area was exposed instead of the whole surface area. The rate of release was slowed but the profile remained essentially the same, showing an initial peak in the amount of additive released which then tailed off as the tablet became exhausted.

With the third tablet only a single face of the tablet was exposed to flow. The resulting profile is generally flat, i.e. an approximately uniform additive release rate was achieved. Such a profile can be achieved using the embodiments of the invention described above.

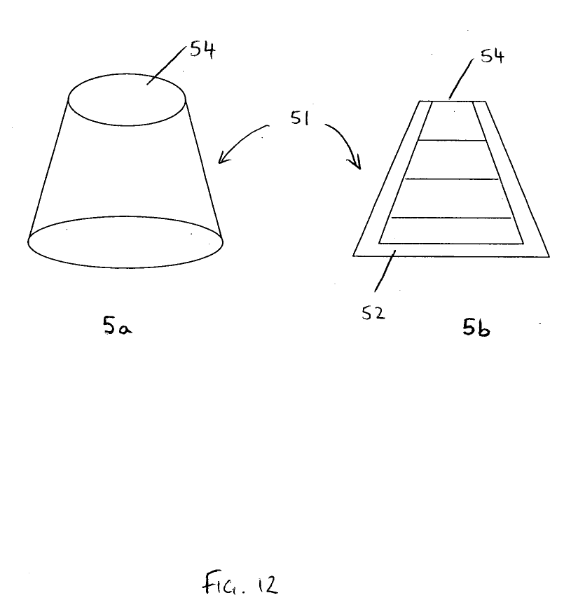

There is shown in FIG. 12 an embodiment of an additive release tablet. The tablet 51 is formed as a truncated cone i.e. it has a frusto-conical shape. The bottom surface and sides of the tablet 51 are sealed, for example with an insoluble coating 52. Only the top surface 54 of the conical tablet 51 is free to leach active components when exposed to water. The shape of the tablet can compensate for the progressively reduced rate of additive release by increasing the surface area of the additive mass available for release as the additive contained in the tablet becomes exhausted, advantageously allowing a more uniform release rate to be achieved throughout the lifetime of the tablet. Such an arrangement can be used whenever the dependence of release rate on remaining additive volume is important.

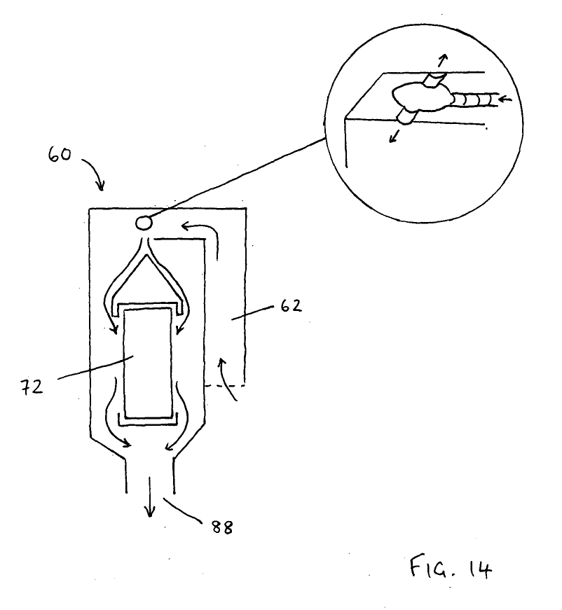

FIG. 14 schematically shows how the U-tube device 60 described above may be adapted to allow two faces of the tablet 72, on either side, to be wetted by the flow passing down the U-tube. By exposing more than one face of the tablet 72 it may be easier to tune the dosing rate achieved. When the flow reaches the uppermost point of the riser tube 62, it is split into two downward flows and directed down both sides of the tablet, onto two exposed faces. A common outlet 88 is provided.

The enlarged portion of FIG. 14 shows one possible way in which the flow from the riser portion 62 can be split into two. As the flow rate across the top of the U-tube device may be relatively low, surface tension effects can make it difficult to split the flow. It may therefore be advantageous to pool the water in a reservoir area which requires a minimum volume to be filled before water can reach the two outflow paths. This can help to stop the water from spreading over a surface and ‘clinging’ instead of flowing. Of course, the flow may be split more than two ways, especially where e.g. the tablet is multi-facetted with several surfaces exposed for wetting.

What is claimed is:

1. A water treatment cartridge comprising an additive channel arranged so that only some of the water passing through the cartridge passes through it, wherein the additive channel comprises means for automatically releasing an additive into the water therein.

2. A water treatment cartridge as claimed in claim 1, wherein the cartridge further comprises a water treatment medium for treating water passing through the cartridge.

3. A water treatment cartridge as claimed in claim 2, wherein an inlet to the additive channel is arranged downstream of a main cartridge inlet and wherein the additive channel is arranged to select a portion of the water flowing through the cartridge after it has been at least partly treated by the water treatment medium.

4-7. (canceled)

8. A water treatment cartridge as claimed in claim 2, wherein an outlet from the additive channel is arranged level with the bottom of, or downstream of, the water treatment medium.

9-10. (canceled)

11. A water treatment cartridge as claimed in claim 1, wherein the means for automatically releasing an additive comprises holder or retainer for an additive release tablet and an additive release tablet exposed to water in the additive channel.

12. (canceled)

13. A water treatment cartridge as claimed in claim 1, wherein the additive channel is configured such that there is a minimum pressure below which water cannot reach the additive release means.

14. A water treatment cartridge comprising means for automatically releasing an additive when exposed to water, and an additive channel arranged to select a portion of the water passing through the cartridge and expose the selected portion to the additive release means when a minimum water pressure is present.

15. A water treatment cartridge as claimed in claim 14, wherein the additive channel is arranged to include a riser portion through which water must flow before reaching the additive release means.

16-17. (canceled)

18. A water treatment cartridge as claimed in claim 14, wherein the outlet of the additive channel is arranged to be isolated from the inlet and wherein the additive channel is arranged such that a rising water level can enter both the inlet and the outlet, thereby creating an airlock in the additive channel in the vicinity of the additive release means.

19-20. (canceled)

21. A water treatment cartridge comprising means for dividing the flow of water through the cartridge into a majority portion for a main flow path and a minority portion for a subsidiary flow path, wherein the subsidiary flow path comprises means for automatically releasing an additive into the water.

22-23. (canceled)

24. A water treatment cartridge as claimed in claim 21, wherein the main flow path comprises a water treatment medium and the subsidiary flow path bypasses at least some of the water treatment medium.

25. (canceled)

26. A water treatment cartridge as claimed in claim 21, wherein the minority portion comprises no more than 10% of the total flow through the cartridge, preferably 5% or less.

27. (canceled)

28. A water treatment cartridge as claimed in claim 21, wherein the subsidiary flow path is formed by a generally tubular insert fitted inside the cartridge.

29. (canceled)

30. A water treatment cartridge as claimed in claim 1, wherein the additive release means provides one or more enhancing additives selected from the group consisting of: vitamins; minerals; antioxidants; herbal remedies; homeopathic remedies; probiotics; antibiotics; and flavorings.

31. (canceled)

32. A water treatment cartridge as claimed in claim 1, wherein the additive release means is arranged so as to have a predetermined surface area exposed to water passing through the additive channel, wherein the exposed surface area is limited to a proportion of the total surface area from which additive release can take place.

34. (canceled)

35. A water treatment cartridge comprising an additive release arrangement for releasing an additive into water comprising an additive mass wherein the surface area of the additive mass exposed to water in use is controlled so as to control the rate of additive release.

36-38. (canceled)

39. A water treatment cartridge as claimed in claim 1, wherein the additive is provided by a tablet having an insoluble substrate matrix holding a soluble additive substance.

40-41. (canceled)

42. A water treatment cartridge as claimed in any claim 1 which is a gravity feed cartridge.

43. A water treatment cartridge as claimed in claim 1, wherein the outlet from the cartridge body is restricted so as to control the flow of water through the cartridge.

44. A water treatment vessel comprising a water treatment cartridge comprising an additive channel arranged so that only some of the water passing through the cartridge passes through it, wherein the additive channel comprises means for automatically releasing an additive into the water therein.

45-46. (canceled)
